(19) United States
(12) Patent Application Publication
(10) Pub. No.: US 2026/0194031 A1
(43) Pub. Date: Jul. 9, 2026

(54) SYSTEMS AND METHODS FOR FLUID PURGING IN A FUEL DELIVERY SYSTEM

(71) Applicant: Woodward, Inc., Fort Collins, CO (US)

(72) Inventors: Michael Hahn, Fort Collins, CO (US); Ethan Altwegg, For Collins, CO (US)

(21) Appl. No.: 19/014,729

(22) Filed: Jan. 9, 2025

(51) Int. Cl. F02M 25/08

(52) U.S. Cl. CPC F02M 25/0836; F02M 25/089

(57) ABSTRACT

Systems and methods are provided for a fuel delivery system. For example, the system includes a purge valve that is connected to a first channel providing fuel to the engine. A shutoff valve is connected to the purge valve via a second channel, the pressure through which can control activation of the purge valve. In activating the shutoff valve, a pressure at the second channel changes from a low pressure to a higher pressure, forcing the purge valve to close. This causes the purge valve to purge a volume of fluid into the first channel, such as in response to a fuel-off situation.

### BACKGROUND

Conventional fuel purging systems move fluid from a low pressure volume to another low pressure volume. This can be achieved using force supplied by a spring. However, such systems are incapable of purging a fluid from a low pressure volume to a higher pressure volume. Thus, systems and methods that enable purging operation for such systems are desirable.

### SUMMARY

Systems and methods are disclosed for fluid purging in a fuel delivery system, substantially as illustrated by and described in connection with at least one of the figures. In particular, the disclosure provides systems and methods for purging fluid from a low pressure channel to a higher pressure channel by a series of valves, as disclosed herein.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1A illustrates a functional diagram of an example system employing a purge valve to deliver fuel to an engine in purge mode, and FIG. 1B illustrates a functional diagram of an example system employing a purge valve in an operating mode, in accordance with aspects of this disclosure.

FIGS. 2A and 2B are cross sectional illustrations of a purge valve, in accordance with aspects of this disclosure.

FIGS. 3A and 3B are cross sectional illustrations of a shutoff valve, in accordance with aspects of this disclosure.

FIGS. 4A and 4B are functional diagrams of other example systems employing a purge valve and a servo switch valve, in accordance with aspects of this disclosure.

FIGS. 5A and 5B are functional diagrams of other example systems employing a purge valve and a shuttle valve, in accordance with aspects of this disclosure.

FIGS. 6A and 6B are functional diagrams of other example systems employing a purge valve and a valve controlled by a solenoid, in accordance with aspects of this disclosure.

FIG. 7 provides an example method of operating a system employing a purge valve, in accordance with aspects of this disclosure.

The figures are not necessarily to scale. Where appropriate, similar or identical reference numbers are used to refer to similar or identical components.

### DETAILED DESCRIPTION

The present disclosure provides systems and methods for a fuel delivery system. For example, the system includes a purge valve that is connected to a first channel supplying fuel to the engine (e.g., during a standard, fuel-on situation). A shutoff valve is connected to the purge valve via a second channel (e.g., a control line), the pressure through which can control activation of the purge valve. A manifold is connected to the shutoff valve and purge valve via a third channel (e.g., a fuel line). In activating the shutoff valve, a pressure at the second channel changes from a low pressure to a high pressure, forcing the purge valve to close. This causes the purge valve to push a volume of fluid into the first channel and pull a volume of fluid from the third channel, such as in response to a fuel-off situation.

The purge or ecology systems and methods disclosed herein can be incorporated into gas turbine products, such as for vehicles (e.g., engine-powered aircraft) but are not so limited.

Conventional purge systems move fluid from a low pressure volume to another low pressure volume (e.g., overboard drain, fuel tank, reservoir, etc.). This can be achieved using force supplied by a spring. However, to purge a system from a low pressure (e.g., operating pressure) to a higher pressure reservoir requires a force from an additional source.

Some purge systems are configured to purge and push fluid to a higher pressure (e.g., 500 pounds-per-square-inch (PSI)) reservoir return pressure volume. When the pressure accumulates to a particular threshold high pressure level, the force required to move the ecology piston (e.g., of a purge valve) is greater than a spring force can apply to the valve alone (e.g., from a mechanical spring or biasing element). Thus, to purge a fuel system to a reservoir with this high pressure, systems and methods to force the fluid to the reservoir with sufficient force is desirable.

In disclosed systems and methods, a shutoff valve (SOV) is employed to switch a control pressure to a purge valve piston. The control pressure controls fluid charging during a fuel-on mode, and can change to a high pressure fluid to purge the fluid during a fuel-off mode. The high pressure fluid, combined with a spring force, overcomes the high pressure exerted on the piston, thereby allowing a purge of a fluid volume during a fuel-off mode.

Advantageously, as explained herein, the disclosed systems and methods are configured to move manifold fuel to a higher pressure fuel source from a lower pressure source. The proposed fuel system maintains desired metering to the engine and controlled purging with minimal impact to fuel system weight, footprint, and complexity.

In disclosed examples, a system to deliver fuel to an engine includes a purge valve connected to a first channel providing fuel to the engine; and a shutoff valve connected to the purge valve via a second channel, wherein activating the shutoff valve causes a pressure at the second channel to change from a low pressure to a higher pressure, forcing the purge valve to close.

In some examples, the purge valve comprises a piston arranged within a chamber, the high pressure at the second channel forcing movement of the piston to close the purge valve.

In examples, the purge valve further comprises a spring arranged within the chamber, wherein forces from the spring and the high pressure at the second channel combining to force movement of the piston.

In some examples, the system further includes a valve operable to connect the first channel with a drain pressure channel.

In some examples, connecting the first channel and the drain pressure channel causes a pressure in the first channel to change.

In examples, the valve is a shuttle valve operable to connect the first channel with the drain pressure channel, causing the pressure in the first channel to decrease.

In examples, the valve is connected to a solenoid, the solenoid operable to change a position of the valve in response to a control signal from an electronic control unit.

In some examples, the system further includes a fuel metering valve connected to the first channel.

In some examples, the system further includes a fuel tank connected to an inlet of the system.

In some disclosed examples, a system to deliver fuel to an engine includes a purge valve connected to a first channel providing fuel to the engine; a shutoff valve connected to the purge valve via a second channel; and a valve operable to connect the shutoff valve with a high pressure channel, wherein connecting the shutoff valve with the high pressure channel causes a pressure at the second channel to change from a low pressure to a high pressure, forcing the purge valve to close.

In some examples, the valve is further operable to connect the first channel with a drain pressure channel, causing a change in pressure at the first channel.

In some examples, the system further includes the valve is a servo switch valve connected to an electronic control unit.

In some examples, the system further includes the electronic control unit is configured to: receive signals corresponding to instructions to activate the purge valve; and activate the servo switch valve to connect the first channel to the drain pressure channel, the pressure in the first channel equalizing with a drain pressure in the drain pressure channel.

In some disclosed examples, a method of purging a fuel delivery system includes charging a first channel with a high pressure fluid from a reservoir; activating a valve to connect the first channel to a shutoff valve; activating the shutoff valve in response to the high pressure fluid; changing a pressure in a purge line between the shutoff valve and a purge valve from a low pressure to a high pressure in response to activation of the shutoff valve; and activating the purge valve based at least in part on the change in pressure in the purge line.

In some examples, the method further includes activating the purge valve includes forcing the purge valve to close in response to the change in the purge line to the high pressure.

In examples, the method further includes forcing the purge valve to close includes forcing a volume of fluid from a chamber of the purge valve into the first channel.

In some examples, the method further includes activating a valve to connect the high pressure channel to a low pressure channel, causing a pressure in the high pressure channel to decrease.

In some examples, the method further includes closing the valve to block connection between the first channel and a drain pressure channel.

In some examples, the method further includes opening the shutoff valve to change the pressure in the purge line from the high pressure to the low pressure.

In some examples, the method further includes opening the purge valve in response to the change in pressure at the purge line from the high pressure to the low pressure.

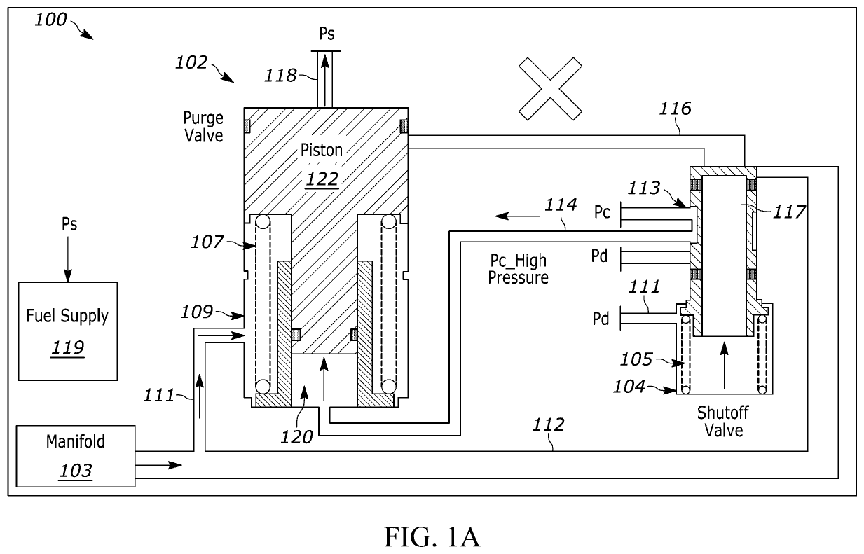

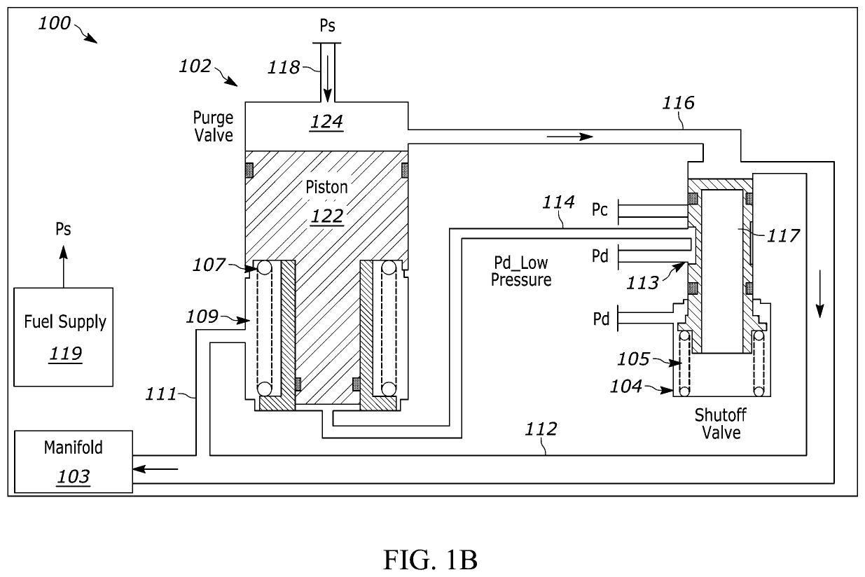

Turning now to the drawings, FIGS. 1A and 1B illustrate detail of a purge valve 102 and a shutoff valve 104 of an example ecology system 100, in accordance with this disclosure. As shown, a purge valve 102 includes a piston 122 and a spring 107. The purge valve 102 includes one or more outlets connected to one or more other system components by one or more conduits. The conduits may convey pressurized fluid between the valves, and/or may connect the valves to additional fluid systems, such as a reservoir. For instance, an outlet or conduit to supply channel 118 is configured to connect to a metering valve for delivery of fuel for a gasoline engine, for example. The purge valve 102 is connected to a manifold 103 containing fluid/fuel, via one or more conduits 111.

The purge valve 102 is further connected to a shutoff valve (SOV) 104 via one or more conduits, including control line 114. Shutoff valve 104 includes a spring 105 and a piston 117. The shutoff valve 104 is configured to convey fluid to the purge valve 102 according to first and second states corresponding to a charged configuration and a purged configuration.

As shown in FIG. 1A, the purge valve 102 and the shutoff valve 104 are in a first state corresponding to a purged configuration. In the first purge configuration, the high pressure (Pc) at the piston 117 is conveyed to the purge valve 102 through the shutoff valve 104 via channel 114. As a result, the higher pressure fluid Pc combines with force from the spring 107 to force the piston 122 toward supply channel 118, closing the purge valve 102.

As the purge valve 102 is forced close, fluid within volume/charge cavity 124 is closed, pushing fluid to the fuel supply 119 by the piston 122 via supply channel 118. Fluid from manifold 103 is pulled into the purge valve purge cavity 109 via conduits 111 and 112, where it remains during the purged state.

In this second state, pistons 122 and 117 are in a position within a chamber of the respective valve, such that springs 105 and 107 are in a partially compressed state. During a transition from the first state to the second state (corresponding to a charged mode), the pressure of the fuel supply (e.g., via a fuel metering valve) is switched from a low pressure (Pd) to a high pressure, and/or the SOV reference pressure is switched from the high pressure (Ps) to a low pressure (Pd). In some examples, a shuttle valve can be included to increase the reference pressure at the SOV. In either of these cases, the pressure from fluid Ps at the shutoff valve 104 is greater than the shutoff valve 104 reference pressure, causing the spring 105 to compress, thereby moving into a second configuration, as shown in FIG. 1B.

In the charged configuration, the shutoff valve 104 conveys a low pressure fluid (e.g., drain pressure Pd) to the purge valve 102 via control line 114. As the pressure from a fuel supply 119 via first channel 118 (e.g., supply channel, at a supply pressure, Ps) is greater than the pressure Pd and the spring force from springs 107 combined, the piston 122 remains in the charged position. This configuration can represent a standard operational mode, while the manifold receives fluid from the fuel supply to fuel the engine.

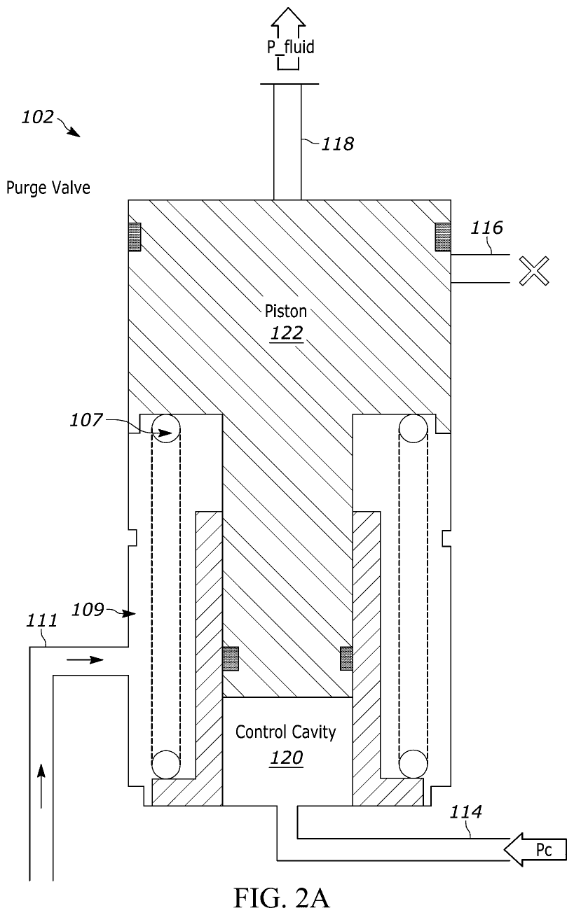

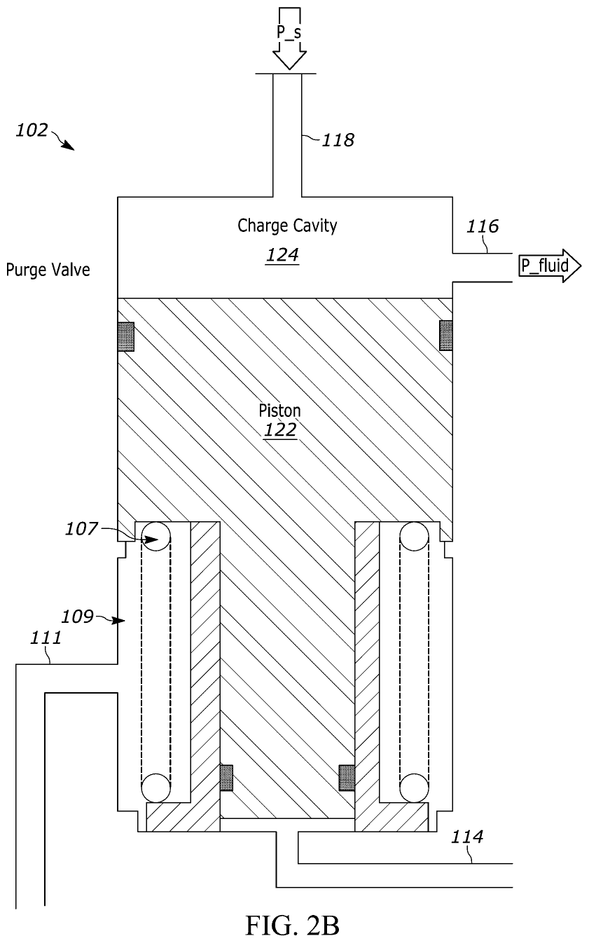

FIGS. 2A and 2B illustrate detailed cross-sectional views of the purge valve 102 in a first position (e.g., purged) and a second position (e.g., charged) corresponding to the first and second states, respectively.

The system enters a purged configuration as the shutoff valve 104 moves from an open position to a closed position, triggered by switching supply pressure (Ps) from a high pressure to a low pressure (Pd), or switching the shutoff valve reference pressure from low pressure (Pd) to supply pressure (Ps). This change in shutoff valve position transitions from conveying low pressure (Pd) fluid to higher pressure fluid (Pc) via control line 114. As the higher pressure fluid Pc fills the control cavity 120, the force of the spring 107 and the high pressure fluid acting on the piston 122 forces the piston into the purged configuration. As a result, fluid is forced from the charge cavity 124 into the fuel supply 119 via channel 118.

To transition from the purged configuration to the charged configuration, the fluid supply pressure changes/increases to high pressure (Ps) and/or the shutoff valve reference pressure transitions to low pressure (Pd). When Ps pressure reaches a threshold level (e.g., above prevailing forces due to movement of the piston 122), the shutoff valve 104 is returned to the charged configuration.

For instance, the piston 117 of the shutoff valve 104 moves within the valve, switching the control ports to the purge valve 102 from high pressure (Pc) to low pressure (Pd). The fluid flowing through control line 114 returns to a low pressure fluid, releasing the high pressure on the control cavity 120 and, thereby, the piston 122.

Opening of the purge valve 102 opens a charge cavity 124, as the ports to conduits 116 and 112 open to fluid from the fuel supply 119. At this configuration, the system is charged and ready for purging once again. For example, as shown in FIG. 2B, when piston 122 is in the second position, the charge cavity 124 is created, as supply channel 118 provides fluid from the fluid supply (e.g., P_fluid). The purge piston 122 pulls fluid from a manifold (not shown) into the purge cavity 109, which serves to prevent fuel coking and deposits while the fluid is not flowing (e.g., in a fuel-off configuration). The purge cavity volume is therefore approximately equal to the piston stroke times a difference between Ps sense the P_control sense areas.

For example, when metered flow is commanded (e.g., standard operation), fluid at control line 114 is at a low pressure (Pd) and the pressure at supply channel 118 is at a high pressure (Ps), this forces the piston 122 to compress the springs 107 into the second state (e.g., the charged position of FIG. 2B).

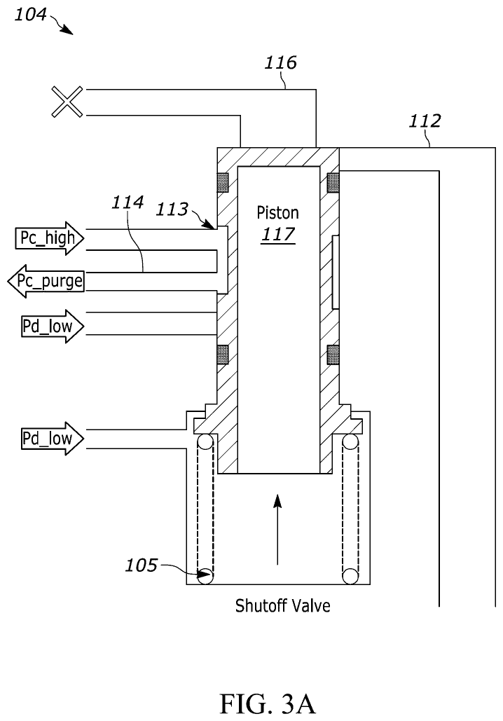

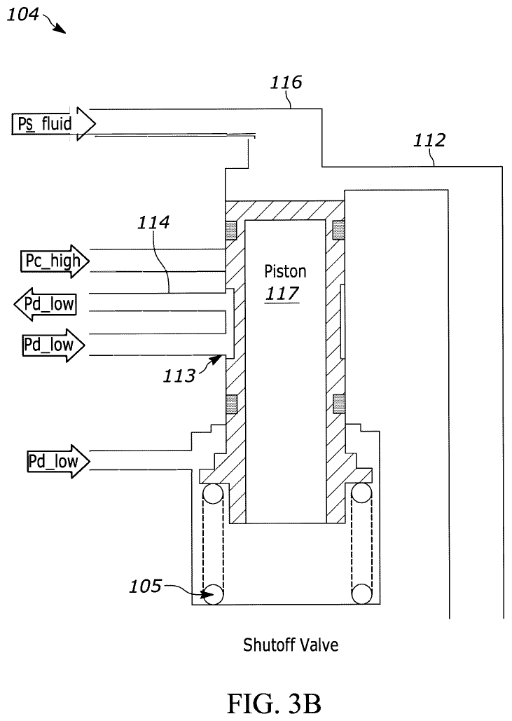

FIGS. 3A and 3B provide detailed cross-sectional views of the shutoff valve 104. As shown, high pressure (Pc) at the control line 114, coupled with the spring 105, provides the force needed to move the piston 122 of the purge valve 102 to close, thereby closing the flow between conduits 112 and 116 the purge configuration. Thus, closing of the piston 117 closes the connection between conduit 116 and conduit 112.

In a charged configuration shown in FIG. 3B, the piston 117 compresses the spring 105 in response to the an increase of pressure from Ps via conduit 116. As the pressure against the piston 117 increases, the piston 117 pushes against the spring 105, again allowing fluid to flow between conduits 116 and 112 in the charged configuration.

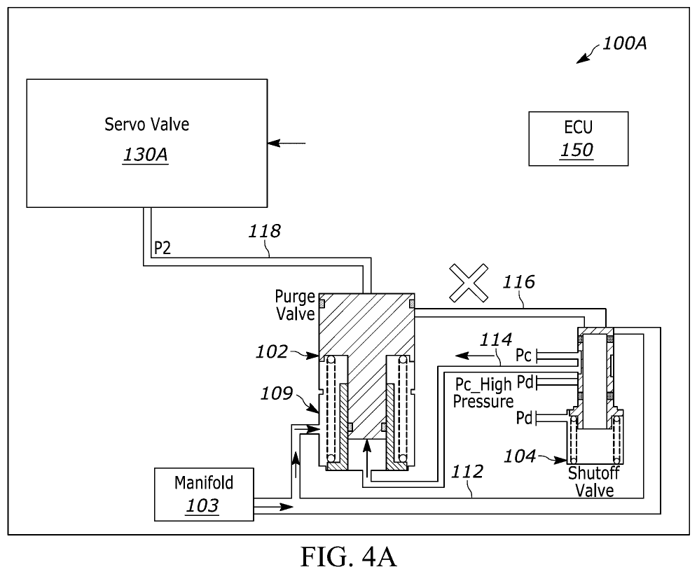

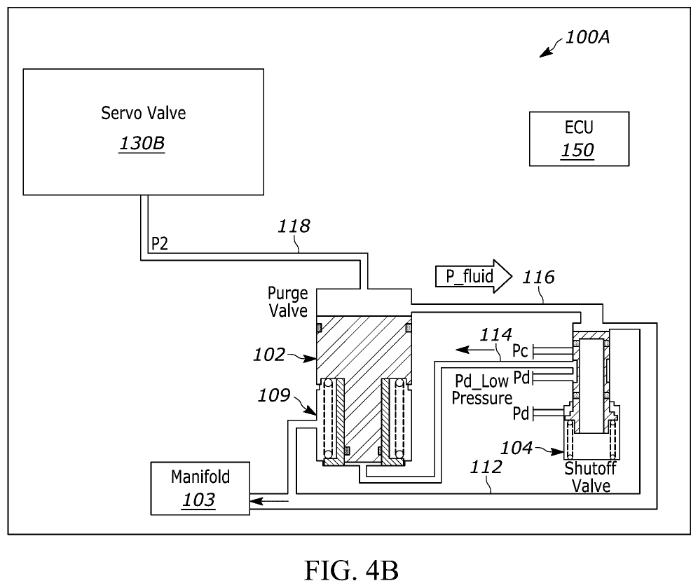

FIGS. 4A and 4B illustrate a cross-sectional view of an example system 100A, which employs a servo switch valve 130A. Similarly to the operation described with respect to FIGS. 1A and 1B, the supply channel 118 (Ps) can be drained via the servo switch valve 130A, from a high pressure at the servo switch valve 130A (during a first state corresponding to an operating mode, shown in FIG. 4A) to a low pressure (during a second state corresponding to a purge mode, shown in FIG. 4B).

As pressure equalizes across the shutoff valve 104 (e.g., experiences a decrease in pressure), the piston 117 of the shutoff valve 104 is forced to close. Upon closing, the fluid conveyed from the shutoff valve 104 to the purge valve 102 via control/purge line 114 changes from low pressure to high pressure. The effect of the high pressure against the piston 122, coupled with forces from the spring, forces the piston to move against the low pressure at supply channel 118, closing the purge valve 102.

Due to movement of the piston 122, fluid is forced to the servo switch valve 130B via supply channel 118, the pressure stabilizes, and fluid from the reservoir fills the purge valve chamber, as shown in FIG. 4A.

In some examples, commands to engage in metered fluid delivery and/or to activate a purge can be initiated by a user input and/or an automatic response. The commands can be communicated to an electronic control unit or control circuitry 150. For example, in some applications electromechanical actuation is employed to change pressure in one or more channels, such as via a servo switch valve and/or solenoid. Electronic control units 150 can be employed to receive user/processor instructions, sensor data, and/or control motor/actuation devices in some examples. The electronic control unit 150 can include one or more components and/or circuitry such as a microprocessor/controller, a memory storage device (e.g., including a listing, matrix, library, etc.), and/or one or more interfaces (e.g., including a user interface, a network interface, a communications interface, etc.). In some examples, the electronic control unit 150 is connected to and/or in wired and/or wireless communication with one or more of the servo switch valve and/or solenoid, as well as other system components, which may include an engine, a sensor, and/or a remote computer, as a list of non-limiting examples.

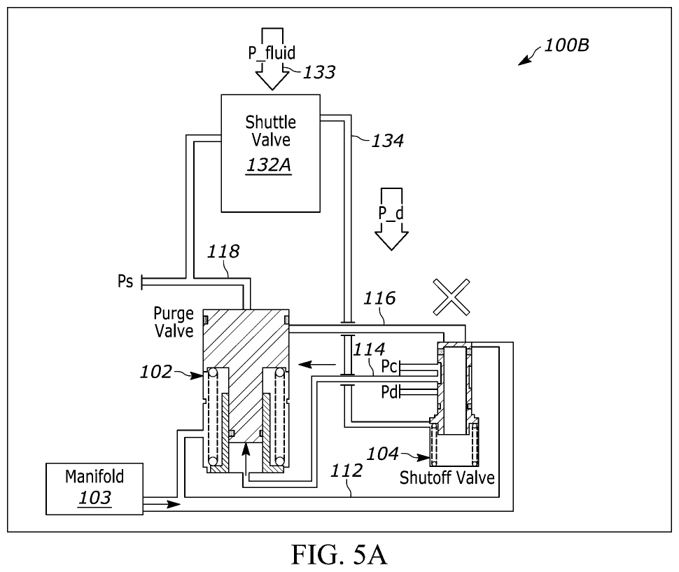

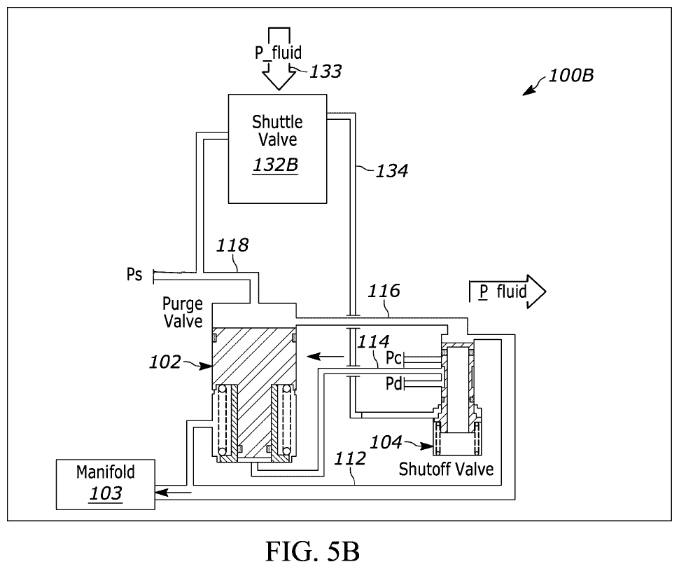

FIGS. 5A and 5B illustrate a cross-sectional view of an example system 100B, which employs a shuttle valve 132A connected to shutoff valve 104 via conduit 134. Responsive to commands to purge, pressure of a fluid provided via conduit 133 can change from low pressure (during a first state corresponding to an operating mode, shown in FIG. 5A) to a high pressure (during a second state corresponding to a purge mode, shown in FIG. 5B).

This causes a piston of the shuttle valve 132 to close. As a result, reference pressure at the shutoff valve 104 switches from low pressure (Pd) to high pressure via the shuttle valve. The fluid in supply channel 118 is drained from high pressure to drain pressure (Pd) via a path through the shuttle valve 132A.

As pressure equalizes across the shutoff valve 104 (e.g., experiences a decrease in pressure), the piston 117 of the shutoff valve 104 is forced to close via spring 105. Upon closing, the fluid conveyed from the shutoff valve 104 to the purge valve 102 via control/purge line 114 changes from low pressure to high pressure. The effect of the at least the high pressure (and/or spring forces) against the piston 122 forces the piston to move, closing the purge valve 102.

Due to movement of the piston 122, fluid is forced to the shuttle valve 130B, the pressure stabilizes, and fluid from the manifold fills the purge valve chamber. In some examples, the fluid can be forced through a shuttle valve or forced through supply channel 118 (e.g., back to Ps).

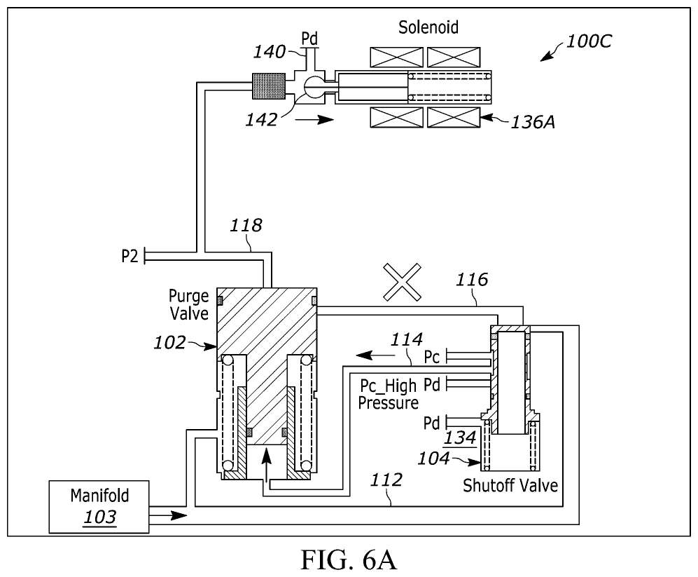

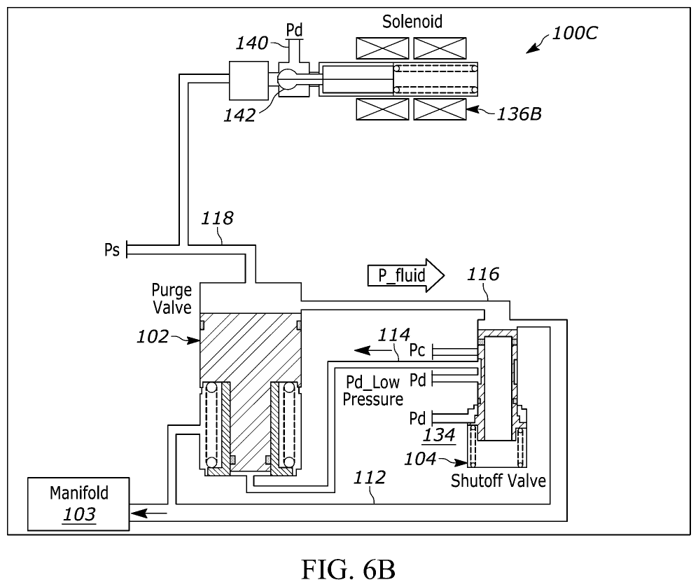

FIGS. 6A and 6B illustrate a cross-sectional view of an example system 100C, which employs a solenoid 136 connected to conduit 134, and controlling a valve 142 at a connection between a low pressure conduit 140 and conduit 134. FIG. 6A illustrates the solenoid 136A in a first state, corresponding to a purged mode. Responsive to commands to purge (e.g., a fuel-off transition), the solenoid 136B moves the valve 142 to drain the fluid in supply channel 118 to low pressure conduit 140 (as shown in FIG. 6B).

This causes a piston of the solenoid valve 136B to close. The fluid in supply channel 118 is drained from high pressure to drain pressure (Pd) via a path through the solenoid valve 136B

As pressure equalizes across the shutoff valve 104 (e.g., experiences a decrease in pressure), the piston 117 of the shutoff valve 104 is forced to close. Upon closing, the fluid conveyed from the shutoff valve 104 to the purge valve 102 via control/purge line 114 changes from low pressure to high pressure. The effect of the high pressure (and/or spring) against the piston 122 forces the piston to move, closing the purge valve 102.

Due to movement of the piston 122, fluid is forced to the supply channel 118, the pressure stabilizes, and fluid from the reservoir fills the purge valve chamber.

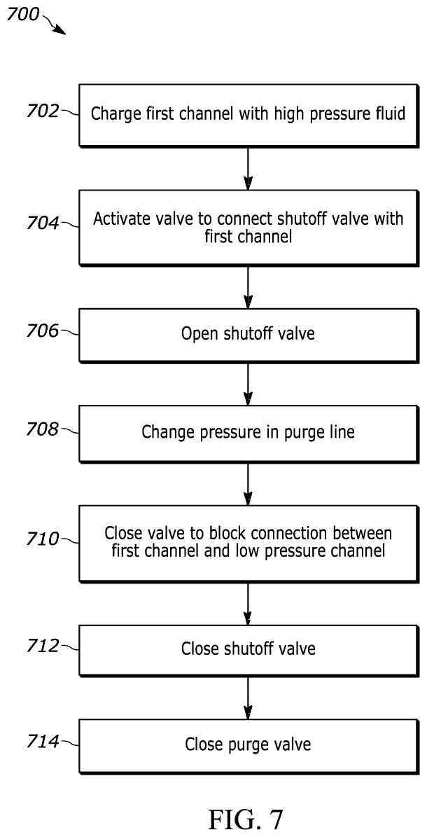

FIG. 7 provides an example method 700 for charging and purging a fuel delivery system. The system starts in the purged state, this is consistent with the fuel off where the system is not flowing (e.g., a default condition).

In block 702, a first channel is charged with a high pressure fluid from a high pressure fluid supply. In block 704, a valve is activated to connect the first channel to a shutoff valve. In block 706, the shutoff valve opens in response to the high pressure fluid. In block 708, a pressure in a purge line between the shutoff valve and a control line changes from a high pressure to a lower pressure in response to opening of the shutoff valve. The system is now in the charged state.

The system is further configured to transition from the charged state to a purged state. For example, the method additionally includes activating another subsystem to decrease fluid supply pressure (e.g., from Ps to Pd) and/or increase shutoff valve reference pressure (e.g., from Pd to Ps).

In block 710, the valve closes to block connection between the first channel and the drain pressure channel. In block 712, the shutoff valve closes to switch the pressure in the control line from the low pressure to the high pressure. In block 714, the purge valve closes in response to the change in pressure at the control line from the low pressure to the high pressure.

As used herein, a circuit includes any analog and/or digital components, power and/or control elements, such as a microprocessor, digital signal processor (DSP), software, and the like, discrete and/or integrated components, or portions and/or combinations thereof.

As used herein, the terms “first” and “second” may be used to enumerate different components or elements of the same type, and do not necessarily imply any particular order. For example, while in some examples a first compartment is located prior to a second compartment in an airflow path, the terms “first compartment” and “second compartment” do not imply any specific order in which airflows through the compartments.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A system to deliver fuel to an engine, the system comprising:
a purge valve connected to a first channel providing fuel to the engine; and
a shutoff valve connected to the purge valve via a second channel, wherein activating the shutoff valve causes a pressure at the second channel to change from a low pressure to a higher pressure, forcing the purge valve to close.

2. The system as defined in claim 1, wherein the purge valve comprises a piston arranged within a chamber, the high pressure at the second channel forcing movement of the piston to close the purge valve.

3. The system as defined in claim 2, wherein the purge valve further comprises a spring arranged within the chamber, wherein forces from the spring and the high pressure at the second channel combining to force movement of the piston.

4. The system as defined in claim 1, further comprising a valve operable to connect the first channel with a drain pressure channel.

5. The system as defined in claim 4, wherein connecting the first channel and the drain pressure channel causes a pressure in the first channel to change.

6. The system as defined in claim 5, wherein the valve is a shuttle valve operable to connect the first channel with the drain pressure channel, causing the pressure in the first channel to decrease.

7. The system as defined in claim 4, wherein the valve is connected to a solenoid, the solenoid operable to change a position of the valve in response to a control signal from an electronic control unit.

8. The system as defined in claim 1, further comprising a fuel metering valve connected to the first channel.

9. The system as defined in claim 1, further comprising a fuel tank connected to an inlet of the system.

10. A system to deliver fuel to an engine, the system comprising:
a purge valve connected to a first channel providing fuel to the engine;
a shutoff valve connected to the purge valve via a second channel; and
a valve operable to connect the shutoff valve with a high pressure channel,
wherein connecting the shutoff valve with the high pressure channel causes a pressure at the second channel to change from a low pressure to a high pressure, forcing the purge valve to close.

11. The system as defined in claim 10, wherein the valve is further operable to connect the first channel with a drain pressure channel, causing a change in pressure at the first channel.

12. The system as defined in claim 10, wherein the valve is a servo switch valve connected to an electronic control unit.

13. The system as defined in claim 11, wherein the electronic control unit is configured to:
receive signals corresponding to instructions to activate the purge valve; and
activate the servo switch valve to connect the first channel to the drain pressure channel, the pressure in the first channel equalizing with a drain pressure in the drain pressure channel.

14. A method of purging a fuel delivery system, the method comprising:
charging a first channel with a high pressure fluid from a reservoir;
activating a valve to connect the first channel to a shutoff valve;
activating the shutoff valve in response to the high pressure fluid;
changing a pressure in a purge line between the shutoff valve and a purge valve from a low pressure to a high pressure in response to activation of the shutoff valve; and
activating the purge valve based at least in part on the change in pressure in the purge line.

15. The method as defined in claim 14, wherein activating the purge valve includes forcing the purge valve to close in response to the change in the purge line to the high pressure.

16. The method as defined in claim 15, wherein forcing the purge valve to close includes forcing a volume of fluid from a chamber of the purge valve into the first channel.

17. The method as defined in claim 14, further comprising activating a valve to connect the high pressure channel to a low pressure channel, causing a pressure in the high pressure channel to decrease.

18. The method as defined in claim 14, further comprising closing the valve to block connection between the first channel and a drain pressure channel.

19. The method as defined in claim 18, further comprising opening the shutoff valve to change the pressure in the purge line from the high pressure to the low pressure.

20. The method as defined in claim 19, further comprising opening the purge valve in response to the change in pressure at the purge line from the high pressure to the low pressure.
